(19) United States
(12) Patent Application Publication
(10) Pub. No.: US 2004/0036711 A1
(43) Pub. Date: Feb. 26, 2004

(54) Force frames in animation

(76) Inventor: Thomas G. Anderson, Albuquerque, NM (US)

Correspondence Address: V. Gerald Grafe, esq., P.O. Box 2689, Corrales, NM, 87048, US

(21) Appl. No.: 10/226,462

(22) Filed: Aug. 23, 2002

(51) Int. Cl. G06T 13/00; G09G 5/00

(52) U.S. Cl. 345/701; 345/473

(57) ABSTRACT

The present invention provides a method of allowing a user to efficiently direct the generation of frames in a computer animation. An object within a frame has an initial representation, e.g., position, orientation, scale, intensity, etc. A vector response characteristic can be associated with the object, where the vector response characteristic specifies how the representation of the object changes in response to applied vectors. For example, a ball might accelerate proportional to the directed magnitude of an applied vector, while a light source might change in intensity and color according to the direction and magnitude of an applied vector. Each object can have its own vector response characteristic, multiple vector response characteristics (e.g., applicable if different parts of the animation), and constraints on its vector response characteristics (e.g., must stay connected to another object). Objects can also generate their own vectors to apply to other objects (e.g., a wall can generate a vector to discourage objects from penetrating the wall).

### PRIORITY CLAIM

This application claims the benefit of U.S. patent application Ser. No. 09/649,853, filed Aug. 29, 2000, which claimed the benefit of U.S. Provisional Application No. 60/202,448, filed on May 6, 2000, each of which is incorporated herein by reference.

### BACKGROUND OF THE INVENTION

This invention relates to the field of computer animation, specifically the use of vectors to facilitate development of images in animation.

An animator has to be able to specify, directly or indirectly, how a ‘thing’ is to move through time and space. The appropriate animation tool is expressive enough for the animator's creativity while at the same time is powerful or automatic enough that the animator doesn't have to specify uninteresting (to the animator) details. There is generally no one tool that is right for every animator, for every animation, or even for every scene in a single animation. The appropriateness of a particular animation tool depends on the effect desired by the animator. For example, an artistic piece of animation can require different tools than an animation intended to simulate reality.

Many computer animation software tools exist. Some contemporary examples include 3D Studio from Kinetix, Animation Master from Hash, Inc., Extreme 3D from Macromedia, form Z RenderZone from auto-des-sys, Lightwave, Ray Dream Studio from Fractal Design, and trueSpace² from Caligari (trademarks of their respective owners). Contemporary animation tools use key frames to allow an animator to specify attributes of an object at certain times in an animation. The animation software interpolates the appearance of the object between key frames. The animator usually must also experiment with a variety of parameters to achieve realistic movement.

The conventional approach to animation requires significant expertise to achieve acceptable results. Interpolation between set positions does not generally yield realistic motion without significant human interaction. Further, the animator can only edit the animation off-line; the key frame approach does not allow interactive editing of an animation while it is running. Also, key frame animation tools can require many graphic and interpolation controls to achieve realistic motion, resulting in a non-intuitive animation interface.

Accordingly, there is a need for improved computer animation processes can produce realistic motion with an intuitive editing and control interface.

### SUMMARY OF THE INVENTION

The present invention provides a method of allowing a user to efficiently direct the generation of an animated sequence frames in a computer animation. The present invention, while compatible with conventional key frames, does not require them. An object within a frame has an initial representation, e.g., position, orientation, scale, intensity, etc. A vector response characteristic can be associated with the object, where the vector response characteristic specifies how the representation of the object changes in response to applied vectors. For example, a ball might accelerate proportional to the directed magnitude of an applied vector (for example, a vector applied by a modeling of physics, or a vector applied by user interaction), while a light source might change in intensity and color according to the direction and magnitude of an applied vector. Each object can have its own vector response characteristic, multiple vector response characteristics (e.g., applicable if different parts of the animation), and constraints on its vector response characteristics (e.g., must stay connected to another object). Objects can also generate their own vectors to apply to other objects (e.g., a wall can generate a vector to discourage objects from penetrating the wall).

The user can apply a vector to an object in the image. The computer can then determine the changes in the object's representation in subsequent frames of the animation from the applied vector and the object's vector response characteristic. The combination of all the changes in the representations of objects allows the computer to determine all the frames in the animation. Vectors can be assigned by rule, e.g., gravitational effects, wave motion, and motion boundaries. The user can supply additional vectors to refine the animated motion or behavior. Changes in representation can include, as examples, changes in the position of the object, changes in the shape of the object, and changes in other representable characteristics of the object such as surface characteristics, brightness, etc.

Using vectors to direct the animation can reduce the need for expert human artists to draw sufficient key frames to achieve realistic animation. Also, refinement of animated motion or behavior can be easier: applying a vector “nudge” to an object can be easier than specifying additional key frames, and can be done interactively in real time, accelerated time, or decelerated time. The user can apply forces to a force sensitive input device to establish the vectors to apply to objects, allowing natural human proprioceptive and kinesthetic senses to help generate an animation.

Advantages and novel features will become apparent to those skilled in the art upon examination of the following description or may be learned by practice of the invention. The objects and advantages of the invention may be realized and attained by means of the instrumentalities and combinations particularly pointed out in the appended claims.

### DESCRIPTION OF THE FIGURES

The accompanying drawings, which are incorporated into and form part of the specification, illustrate embodiments of the invention and, together with the description, serve to explain the principles of the invention.

FIG. 1 is a sequence of images from an animation in accord with the present invention.

FIG. 2 is a sequence of images from an animation in accord with the present invention.

FIG. 3 is a sequence of images from an animation in accord with the present invention.

FIG. 4 is an image showing vectors specified as a field therein.

FIG. 5 is a sequence of images from an animation in accord with the present invention.

FIG. 6 is a sequence of images from an animation in accord with the present invention.

FIG. 7 is a schematic representation of a computer system suitable for use with the present invention.

FIG. 8 is a flow diagram of an example computer software implementation of the present invention.

### DETAILED DESCRIPTION OF THE INVENTION

The present invention provides a method of allowing a user to efficiently direct the generation of frames in a computer animation. An object within a frame has an initial representation, e.g., position, orientation, scale, intensity, etc. A vector response characteristic can be associated with the object, where the vector response characteristic specifies how the representation of the object changes in response to applied vectors. For example, a ball might accelerate proportional to the directed magnitude of an applied vector; a light source might change in intensity and color according to the direction and magnitude of an applied vector; a shape might deform in response to an applied vector. Each object can have its own vector response characteristic, multiple vector response characteristics (e.g., applicable if different parts of the animation), and constraints on its vector response characteristics (e.g., must stay connected to another object). Objects can also generate their own vectors to apply to other objects (e.g., a wall can generate a vector to discourage objects from penetrating the wall). Behavior of objects can also be relative to another, for example fingers can be defined to move relative to a hand.

The user can apply a vector to an object (or collection of objects) in the image. The computer can then determine the changes in the object's representation in subsequent frames of the animation from the applied vector and the object's vector response characteristic. The combination of all the changes in the representations of objects allows the computer to determine all the frames in the animation. Vectors can be assigned by rule, e.g., gravitational effects, wave motion, and motion boundaries. The user can supply additional vectors to refine the animated motion or behavior. These force or vector techniques can be used in conjunction with traditional animation practices such as inverse kinematics (where certain object-object interactions follow defined rules).

Using vectors to direct the animation can reduce the need for expert human artists to draw sufficient key frames to achieve realistic animation. Also, refinement of animated motion or behavior can be easier: applying a vector “nudge” to an object can be easier than specifying additional key frames. The user can apply forces to a force sensitive input device to establish the vectors to apply to objects, allowing natural human proprioceptive and kinesthetic senses to help generate an animation.

Simplified Example Animation Process

FIG. 1 is a sequence of images from a simple animation. The images in the sequence are shown with large motion between images for ease in presenting the operation of the present invention. Ghosts of previous images are shown in this and other animation sequences presented here to help understand the changes between the images. An actual animation can comprise many images, with small displacements between adjacent images. Initial image I101 comprises an object X1 represented at a specific location within image I101. The user specifies a vector V1 to be applied to object X1, where vector V1 can comprise a magnitude, a direction, and an application time. The user interaction can comprise simply pushing on an object in the image; the correlation of the force, direction, and time of the push with the desired animation behavior can be determined by computer software. Object X1 can have a vector response characteristic associated; for simplicity, consider a vector response characteristic where the acceleration of the object's representation in the image is in the direction of the applied vector and proportional to the magnitude of the applied vector.

Given the initial image, the vector response characteristic, and the applied vector, the computer can determine subsequent images in the sequence. Image I102 shows a subsequent image, where object X1 has moved to the right in response to acceleration due to the applied vector V1. Vector V1 is shown as applied for both image I101 and I102. Object X1 has moved farther to the right in image I103 in response to acceleration due to the application of vector V1 in images I101 and I102; vector V1 is no longer being applied in image I103. Images I104 and I105 show object X1 as it moves farther to the right. Note that the computer can generate the middle and ending images in the sequence, in contrast to key frame animation processes where the user must specify the initial and end frames, leaving the computer to interpolate only the intermediate frames.

FIG. 2 is another sequence of images, illustrating a sequence editing capability of the present invention. Consider the image of FIG. 1, displayed to the user. Farther, consider that the user desires that object X1 begin to move downward as well as rightward beginning in image I103. Image I203 in FIG. 2 shows image I103 of FIG. 1, with a user-specified vector V2 directed downward applied to object X1. Object X1's vector response characteristic specifies that object X1 accelerate in response to vector V2. Image I204 corresponds to image I104, except that object X1 has moved downward as well as rightward. Image I205 shows object X1 as it moves farther along the rightward and downward path. The motion specified by vector V1 can be combined by the computer with motion specified by vector V2 to produce the desired motion.

Similarly, if the user wanted object X1 to accelerate faster, an additional vector could be added to vector V1. If the user desired that object X1 decelerate after a certain image, a vector opposing the motion could be applied in that image. Accordingly, the user can specify the initial image and how the object is to behave (the vector response characteristic). The computer can then determine all the images in the sequence without the requirement for key frames. The user can specify the motion by applying vectors to objects in the images in the sequence, and can edit the resulting animation intuitively by applying additional vectors.

Force-Specified Vectors

The simplified animation above involved vectors specified by the user. The animation system can allow the user to specify vectors according to many user interaction paradigms. Using a force feedback interface can provide efficient and intuitive specification of vectors and can provide efficient feedback to the user.

A user can manipulate an input device to control position of a cursor represented in the image. The interface can determine when the cursor approaches or is in contact with an object in the image, and supply an indication thereof (for example, by highlighting the object within the image, or by providing a feedback force to the input device). As used herein, interaction with an object can comprise various possible interactions, including as examples directly with the object's outline, with an abstraction of the object (e.g., the center of gravity), with a bounding box or sphere around the object, and with a representation of some characteristic of the object (e.g., brightness or deformation). Interaction with an object can also include interaction with various hierarchical levels (e.g., a body, or an arm attached thereto, or a hand or finger attached thereto), and can include interaction subject to object constraints (e.g., doors constrained to rotate about a hinge axis). The user can then specify a vector to apply to the object by manipulating the input device to apply a force thereto. The vector specified can be along the direction of the force applied by the user to the input device, and can have a magnitude determined from the magnitude of the applied force. The specification of vectors to apply within the animation is then analogous to touching and pushing on objects in the real world, making the animation editing interface efficient by building on the user's physical world manipulation skills.

For animatable objects whose vector response characteristics comprise a relationship between position and applied vector, the use of force input to specify vectors can provide an even more intuitive interface. Consider a vector response characteristic where the rate of change of the object's movement in the image is proportional to the applied vector. This relationship parallels the physical relationship F=ma; the user can thus intuitively control objects in the animation by pushing them around just as in the physical world.

The animation system can also allow the user to interact during replay of a sequence of images. The system can provide force feedback to the input device representative of interactions between the cursor and objects within the animation. The user accordingly can feel the characteristics, e.g., position or motion, of objects as they change within the animation sequence. The animation system can also allow the user to apply vectors by applying force via the input device, allowing the user to feel and change objects in the animation in a manner similar to the way the user can feel and change objects in the physical world. The use of skills used in the physical world can provide an intuitive user interface to the animation, increasing the effectiveness of the animation system in generating an animation sequence desired by the user.

Vectors Generated by Objects

The use of vectors to control the representations of objects can also provide simple solutions to some vexing problems in conventional animation systems. Objects in the animation can have associated vector generation characteristics. The vector generation characteristics can be activated by conditions within the animation to allow some aspects of object interaction to be controlled without detailed control by the user.

As an example, consider the simple animation sequence shown in FIG. 3. An object X3 has a vector V3 applied in the first image I301. Object X3 moves rightward in response to the vector V3, as shown in images I302, I303. Object X3 is in contact with wall W3 in image I303. The animator desires that the object X3 rebound from wall W3 without penetrating the surface of wall W3. In a conventional animation system, the user must specify a key frame at image I303, and direct the computer to interpolate motion toward the wall from image I301 to image I303, and motion away from the wall from image I303 to image I304. Each such collision or interaction can require user specification of another key frame and direction for interpolation. In contrast, the wall W3 can have a vector generation characteristic that is activated by a contact between an object and specified boundaries of wall W3. In the example animation, wall W3 can have a vector generation characteristic that applies a vector directed normal to the surface having magnitude sufficient to prevent penetration of the object into wall W3. Alternatively, the vector generation characteristic can generate a vector having magnitude sufficient to reverse the object's velocity component normal to the surface. The user can edit the vector generation characteristic (e.g., direction, magnitude, duration) to achieve the desired behavior of interactions with wall W3; all interactions of objects with wall W3 will then generate the desired animated behavior without additional user key frame specification.

Vectors Generated According to Rules

Similarly, vectors can also be applied by the animation system according to rules defining the desired behavior during portions of the animation. Rule-generated vectors can apply in spatial regions of an image (e.g., apply vector V4 to all objects in the lower half of the image), and can apply in temporal regions of the animation (e.g., apply vector V5 to all objects during a specified range of images). The rule-generated vectors can be modified by user-supplied vectors, for example a user vector can direct motion of a hand to a surface, or through a surface, generating a different rule-based behavior based on the specifics of the user interaction.

As an example, consider a rule that applies a vector whose magnitude is proportional to a constant linking the magnitude of the vector to acceleration of objects, and whose direction is downward in the image. The application of such a rule-based vector would generate a constant downward acceleration on all such objects, mimicking the effect of gravity. Every object's motion would then have a realistic gravity-induced motion component without the user having to explicitly account for gravity in specifying key frames and interpolation as in conventional animation systems. The user can still modify an object's response; for example, the user can apply the gravity vector to all objects except an antigravity spaceship, or can suspend or reduce the gravity vector when animation pertains to motion in low gravity surroundings. As with object-generated vectors, the user can experiment to generate the desired behavior in the presence of a gravity or other rule-based vector; after that, the animation system can generate the user's desired animation behavior without explicit user instruction.

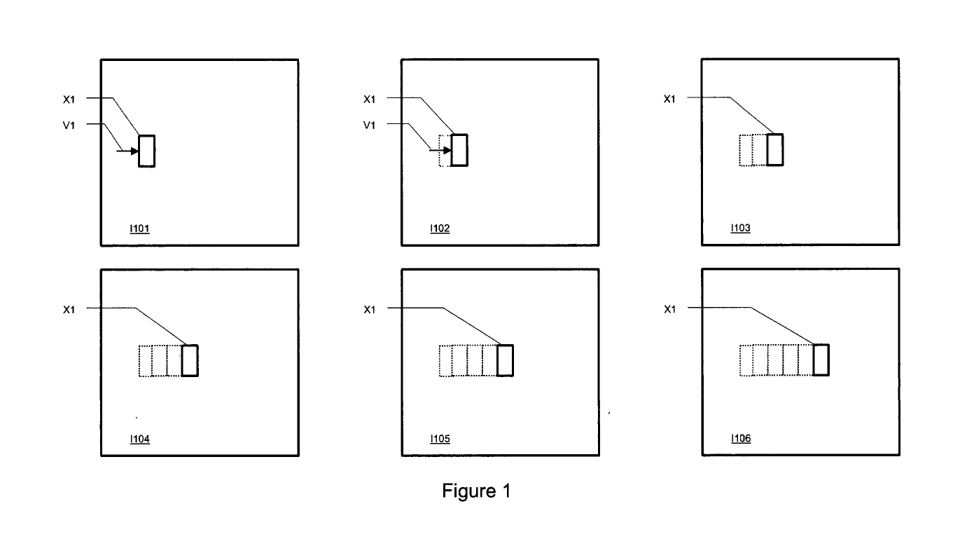

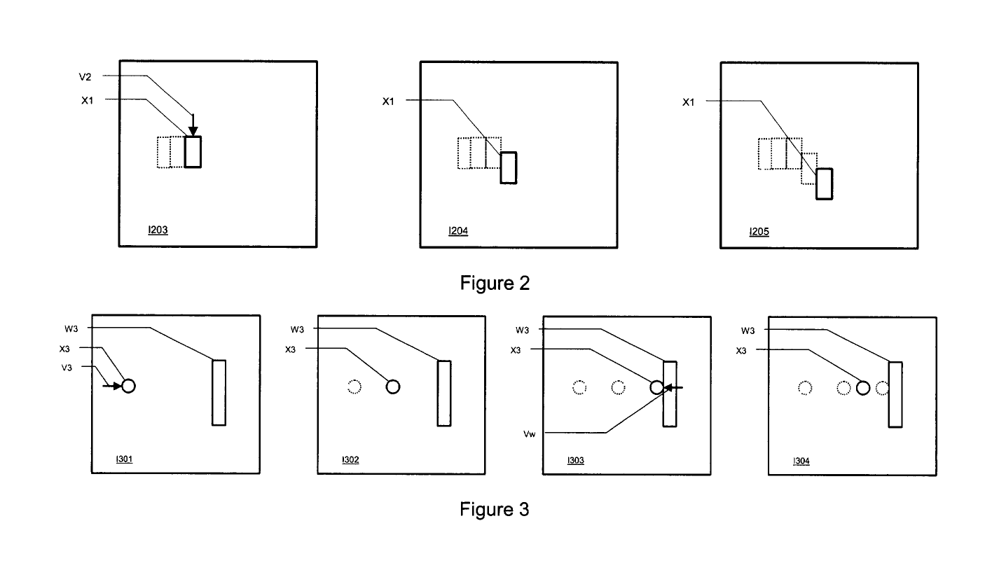

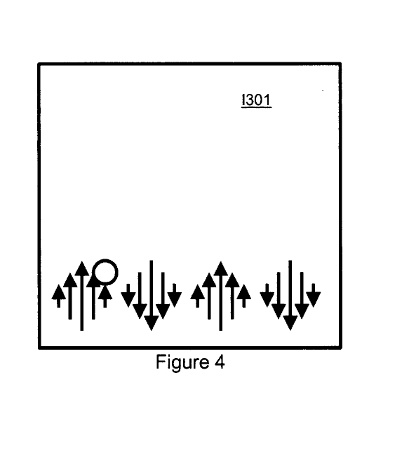

As another example, consider a vector field defined to be directed upward, with magnitude varying in time and space from a positive extreme to a negative extreme. The vector field can be defined to affect objects within a defined region of the image. FIG. 4 shows such a vector field, where varying vectors are applied to objects in the lower portion of the image. Objects affected by the vector field will be accelerated up and down, mimicking the action of waves. As with the other rule-based vectors, the user can experiment to achieve the wave motion effect desired, then allow the vector field to apply that desired motion to appropriate objects.

Objects with Constraints

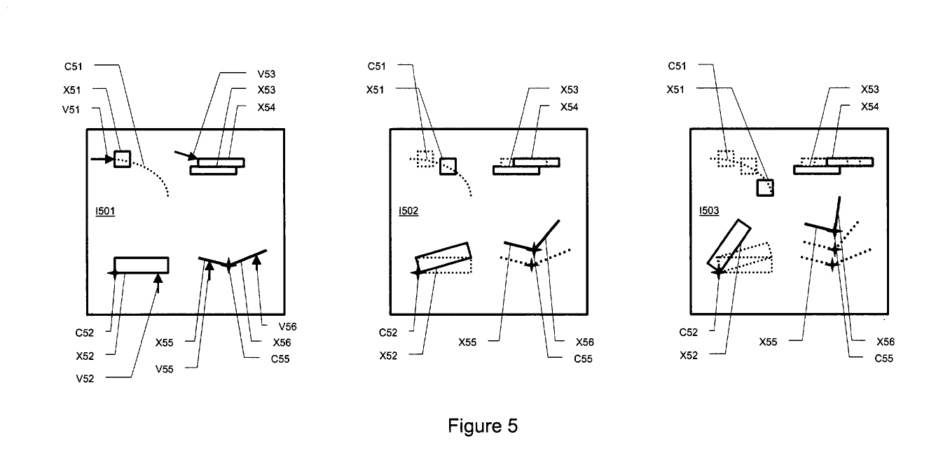

An object's vector response can be modified by a variety of constraints. FIG. 5 illustrates several of such constraints as they affect an animation. Object X51 has a constraint applied that limits its motion to path C51. A vector V51 applied to object X51 in image I501 initiates motion of object X51, constrained to be along path C51 as shown in subsequent images I502, I503.

Object X52 has a rotational constraint C52 applied that limits its motion to be rotation about the corner where the constraint is applied. A vector V52 applied in image I501 initiates motion of object X52. The constraint C52 limits the motion, however, so that the corresponding corner of object X52 is not allowed translational motion. Consequently, object X52 responds to vector V52 by rotating about the corner, as shown in images I502, I503.

Relationships between objects can also be accommodated with constraints. As an example, object X54 can be constrained to motion along the common boundary with object X53. Motion of object X54 consequently appears as sliding along the boundary, as shown in images I502, I503. As another example, objects X55, X56 are connected by a hinge or pin joint. Vector V55 applied to a parent object, object X55 in the figure, can be transmitted to linked object X56. Consequently, motion of parent object X55 also causes corresponding motion of linked object X56. Further, vector V56 applied to linked object X56 can initiate motion of linked object X56 about the hinge connection, causing a rotation of object X56 about the hinge connection (similar to the rotational constraint discussed above, except that the rotation point moves with parent object X55). The resulting coordinated motion is shown in images I501, I503, I503. The transmission of forces between parent and linked objects can reflect forward or inverse kinematics, animation concepts known in key frame animations that can also serve in vector-based animation. A user can be provided with interface control of how vectors are applied to objects or groups of objects, e.g., a vector can be applied to a hand, or wrist, or arm, depending on a specification of the user.

Vector Control of Other Aspects of Animation

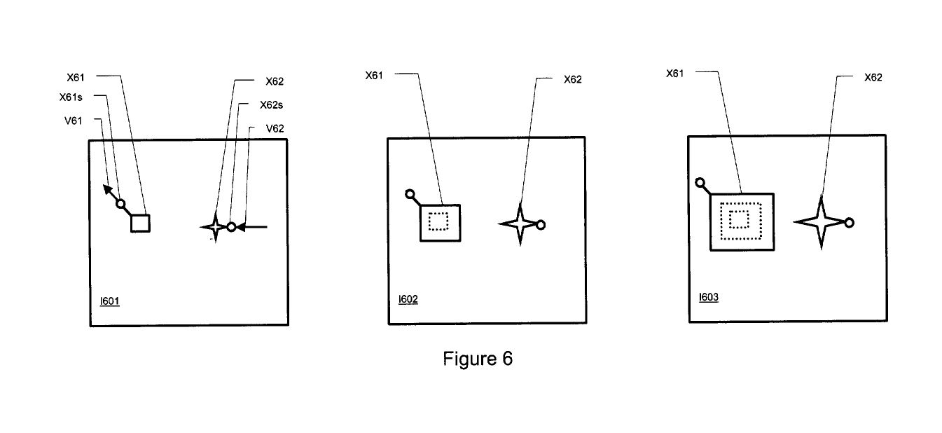

Vectors can also be used to control aspects of an animation other than position. Several representative examples are shown in FIG. 6. An object X61 can have a vector response characteristic that includes change in scale in response to a vector V61 applied to a scale handle X61s associated with the object X61. The computer can then determine the change in scale of object X61 from the initial image I601 and the scale vector response characteristic, producing an animation sequence as illustrated in images I602, I603.

Another object X62, such as a light source, can have a vector response characteristic that includes a change in intensity in response to a vector V62 applied to an intensity handle X62s associated with object X62. The intensity of object X62 is represented in the figure by the length of rays emanating therefrom. Vector V62 can initiate a decrease in intensity of object X62, with the specifics of the decrease determined by the computer from the intensity vector response characteristic, as shown in images I602, I603.

Animation Tool Implementation

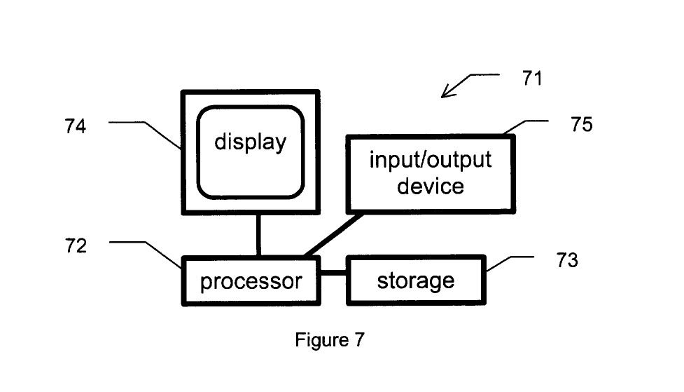

An animation system according to the present invention can be implemented on a computer system 71 like that shown in FIG. 7. A processor 72 connects with storage 73. Display 74 communicates visual representations of the animation to a user responsive to direction from processor 72. Input/output device 75 connects with processor 72, communicating applied user controls to processor 72 and communicating feedback to the user responsive to direction from processor 72. Storage 73 can include computer software implementing the functionality of the present invention. As an example, suitable computer software programming tools are available from Novint Technologies. See, e.g., “e-Touch programmer's guide” from etouch3d.org, incorporated herein by reference.

Example Animation

To further illustrate an application of the present invention, a sample interactive generation of an animation sequence is described. The overall effect desired for the example is of a bunny hopping across the screen. Various steps in generating the desired effect are discussed, along with user interactions according to the present invention that allow efficient control of the animation.

The user begins with a representation of a bunny in a scene. The user positions a cursor near the lower left of the bunny, then pushes upwards and to the right. The animation system interprets that input force to begin moving the bunny upwards and to the right. The animation system can have a gravity force applied to the bunny, causing the upward motion to slow and eventually reverse, bringing the bunny back to the representation of the ground. The ground can have a force applied that exactly counters the gravity force (or the gravity force can be defined to end at the ground), so that the bunny comes to rest on the ground. The user can repeat the application of input force several times to generate the macro motion of the bunny across the scene.

Suppose that, after playing the animation several times at various speeds, the user decides that the bunny rises too quickly on the first jump. The use can apply a force directed downward, for example by positioning a cursor and pushing down on the bunny's head, in real time during playback. The net of the original force, the gravity force, and the downward force, slows the bunny's rate of rise in the first jump. The user can apply other forces, in various directions and magnitudes, as the animation plays to produce the desired macro motion across the scene.

Once the user has the bunny's hopping trajectory satisfactory, the user can use the tool to animate the bunny's legs. The user can specify to control the legs' motion using inverse kinematics. The user can push or pull the legs, either one at a time or paired. The user urges the feet downward while the bunny is rising. The hopping motion is not affected, but the bunny's legs move relative to the body in response to the user's input force. The user can reply the animation, at various speeds, applying corrective force inputs to tweak the motion until the legs and body look like the user desires.

Suppose that the overall effect is still not exactly what the user desired—the user wants the bunny to lean forward as it hops. The user can push on the bunny's back, not affecting the hopping or leg motion, but causing the bunny to lean forward slightly while it hops.

Suppose that the user desires the bunny to hop three times, land, then turn and speak. The hopping motion is now correct, so the user now animates the rest. The user can select the head, and rotation, to enable a control point correlated with rotation of the head. The user can push or pull on the control point to animate the amount and rate of head turning. As before, the user can tweak the motion during playback iterations.

As the bunny begins to speak, suppose that the bunny puffs its cheeks before speaking. The user can activate a control point related to the bunny's cheeks, and pull the control to deform the bunny's face to produce the appearance of cheeks filling with air. The user can then activate a combination of controls to push and pull the bunny's lips to animate the desired talking motions.

Finally, suppose that the user wants a puff of dust to rise when the bunny finally lands. The user can place a group of dirt particles where the bunny lands. A dust tool can be activated, for example by selecting an icon having a handle attached to a hoop. The user can sweep the dust tool through the dirt particles—with each sweep, all the particles within the hoop are moved slightly in the direction of the sweep. The user can make multiple passes with the dust tool, including refinements after, and while, viewing the animation, to produce the desired puff of dust.

Once the animation of the object is defined, the actual images can be generated using conventional animation tools, for example, ray tracing. The user interface can also allow manipulation of light sources and cameras, supplementing traditional animation controls with force-based interaction.

Example Interface Implementation

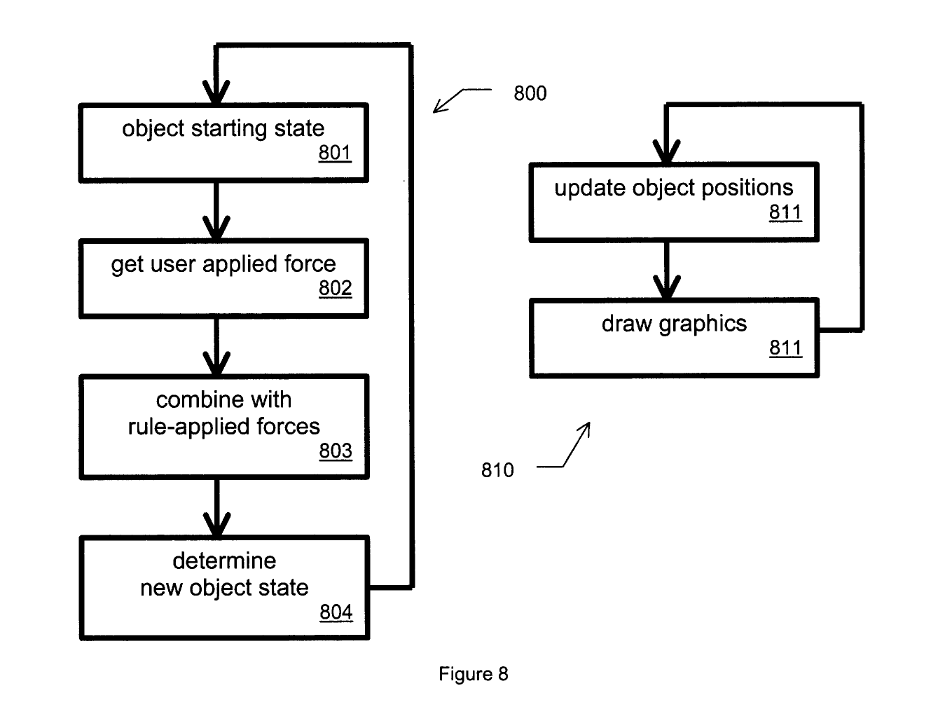

FIG. 8 is a flow diagram of an example computer software implementation of the present invention. In the figure, the user has activated or otherwise indicated an object that is to be controlled. The object initially assumes a starting state (e.g., position) 801. The interface acquires a force, e.g., magnitude and direction applied to an input device, indicating a desired change in the object's state 802. The interface then combines that force with other forces acting on the object, e.g., forces applied by rules such as gravity emulation 803. The combined forces affecting the object are used to determine a new state for the object (e.g., a new position, orientation, or deformation), and the sequence repeated. This haptics iteration 800 can operate at a high iteration rate to provide intuitive force-based interaction. 1000 Hz iteration rates have been found to be suitable for use with contemporary haptic interface devices.

While the interface is updating objects' state responsive to user input, it can also provide the user a visual feedback of the animation state 810. The states of all the objects visible in the scene can be determined 811 based on the results of the haptic iteration 800. The graphical representation of the objects, given their current state, can then be generated and presented to the user 812. This graphics iteration 810 can operate at a lower iteration rate than the haptics iteration 800. 30 Hz is often found to be a suitable iteration rate for graphics generation. After the user interaction is complete, the graphics iteration 810 can be used to generate the final animation visual sequence. Conventional rendering techniques can be used to produce visual images of the quality desired.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

We claim:

1. A method of changing the computer representation of an object through time, responsive to a vector applied to the object, comprising:
a) Assigning a vector response characteristic to the object;
b) Determining the current computer representation of the object;
c) Determining the direction and magnitude of the vector; and
d) Changing the computer representation of the object according to the vector response characteristic, the current computer representation, and the direction and magnitude of the vector.

2. The method of claim 1, wherein the step of determining the direction and magnitude of the vector comprises determining the direction and magnitude of a force applied by a user to a force sensitive input device.

3. In a computer animation system comprising an initial graphical representation of an object, a method of generating a sequence of graphical representations of the object comprising:
a) Assigning a vector response characteristic to the object;
b) Determining a vector to be applied to the object;
c) Determining graphical representations within the sequence from the vector, the vector response characteristic, the location of the representation within the sequence, and another graphical representation within the sequence.

4. The method of claim 3, wherein the step of determining a vector comprises determining the direction and magnitude of a force applied by a user to a force sensitive input device.

5. A method of using a computer to generate from an initial image a generated image comprising graphical representations of one or more objects, comprising:
a) Assigning a vector response characteristic to an animatable object in the initial image;
b) Determining a vector to be applied to the animatable object;
c) Determining a change in the graphical representation of the animatable object according to the applied vector and the vector response characteristic; and
d) Determining the generated image from the initial image and the change in the graphical representation of the animatable object.

6. The method of claim 5, wherein the step of determining a vector comprises determining the direction and magnitude of a force applied by a user to a force sensitive input device.

7. A method of using a computer to generate a sequence of images, comprising:
a) Providing for user definition of an initial image, where the initial image comprises a representation of at least one animatable object;
b) Providing for user specification of vector response characteristics for the animatable objects in the initial image;
c) Accepting from the user specification of vectors to be applied to animatable objects in the initial image;
d) Determining the representations of the animatable objects in subsequent images in the sequence from their representations in the initial image, their vector response characteristics, and any vectors specified to be applied thereto;
e) Determining subsequent images in the sequence from the representations of the animatable objects and the initial image.

8. The method of claim 7 further comprising accepting from the user specification of vectors to be applied to animatable objects beginning at images in the sequence other than the initial image.

9. The method of claim 7 further comprising:
f) displaying the sequence of frames to a user;
g) accepting from the user specification of vectors to be applied to animatable objects at images in the sequence other than the initial image;
h) combining the effects of all the vectors to be applied to each animatable object;
i) repeating steps d) and e) responsive to additional vectors input by the user.

10. The method of claim 7 wherein step c), accepting from the user specification of vectors, comprises determining the magnitude and direction of force applied by the user to a force-sensitive input device, and determining the vector according to the magnitude and direction of the force.

11. The method of claim 9 wherein step g), accepting from the user specification of vectors, comprises determining the magnitude and direction of force applied by the user to a force-sensitive input device, and determining the vector according to the magnitude and direction of the force.

12. The method of claim 7 wherein a vector response characteristic comprises a relationship between the position within an image of an object's representation and a vector applied to the object.

13. The method of claim 7 wherein a vector response characteristic comprises a relationship between the change in position within an image of an object's representation and a vector applied to the object.

14. The method of claim 7 wherein a vector response characteristic comprises a constraint on change in the associated object's representation.

15. The method of claim 7 wherein a vector response characteristic comprises a relationship of a vector applied to the object to a vector generated by the object.

16. The method of claim 7 further comprising accepting from the user specification of vectors corresponding to a region within an image to be applied to objects that enter the region.
